(19) United States
(12) Patent Application Publication
(10) Pub. No.: US 2023/0246569 A1
(43) Pub. Date: Aug. 3, 2023

(54) SUPERLEV VEHICLE SYSTEM FOR TRANSPORTING ENERGY, PEOPLE, AND GOODS

(71) Applicant: UNIVERSITY OF HOUSTON SYSTEM, Houston, TX (US)

(72) Inventor: Zhifeng Ren, Pearland, TX (US)

(21) Appl. No.: 18/160,803

(22) Filed: Jan. 27, 2023

Related U.S. Application Data
(60) Provisional application No. 63/304,366, filed on Jan. 28, 2022.

(51) Int. Cl. H02N 15/00; H01F 6/04; H01B 12/02

(52) U.S. Cl. CPC H02N 15/00; H01F 6/04; H01B 12/02

(57) ABSTRACT

A superconductor levitation (superlev) vehicle system and method of transporting and storing coolant and fuel that includes a guideway comprising a conduit. The conduit includes a superconductor and a coolant coupled to the superconductor. The coolant is configured to cool the superconductor. A magnetic vehicle that is configured to be levitated a distance from the guideway via interaction between a magnetic field from the vehicle and a magnetic field from the superconductor. The superconductor may also be used to transport and store electrical power, and the conduit may be used to transport and store liquids and/or fuels.

### PRIORITY

This application claims the benefit of U.S. Provisional 63/304,366, filed Jan. 28, 2022, which is hereby incorporated by reference in its entirety.

### BACKGROUND OF THE INVENTION

Magnetic levitating (maglev) trains for transportation have been demonstrated that employ a bulk superconductor levitated above a permanent magnet guideway. The train is propelled using a linear motor due to a flux-pinning phenomenon of type-II superconductivity. Separately, superconducting cables have been used to transmit and store electrical power without losses over long distances. Such superconducting cables may have a significant advantage over current transmission cables, which can lose power due to resistance. Further, hydrogen (H₂) provides an energy source that may be used to replace fossil fuels. For such systems, liquid H₂ (LH₂) pipelines may be used for the transportation and storage of the hydrogen. In addition, other liquids such as liquid nitrogen, liquid natural gas, etc. can also be stored and transported over long distance.

However, long-distance superconducting maglev trains require many high-cost permanent magnets positioned in the guideway. These magnets merely service the functions of high-speed mass transit and freight transport. Also, there are few long-distance applications of superconducting power transmission cables due to the technological deficiencies and high cost of the superconducting cables. In such systems, the superconducting cables merely service the functions of transmitting and storing the electrical power. Still further, a system of LH₂ pipelines will require a high-cost thermal insulation to maintain the LH₂ at 20 K (the condensation temperature). Currently, the manufacturing of such expensive LH₂ pipelines for the purpose of LH₂ transport and storage is not available. Furthermore, because hydrogen is the lightest element, the high pressure required to transport gaseous H₂ may pose additional challenges.

### SUMMARY

Embodiments disclosed herein may overcome some of the above deficiencies by providing a novel superlev vehicle system capable of transporting and storing electrical power, fuel (gas or liquid), and/or people or goods. Embodiments include a superlev vehicle (e.g., train, bus, truck, car) levitating over superconducting cables cooled by a coolant. The superconducting cables and coolant may also be used to transport electricity and fuel (such as LH₂), and these fuels can also be stored in the system.

### BRIEF DESCRIPTION OF THE DRAWINGS

FIG. 1 shows a schematic illustrating a system in accordance with one or more embodiments disclosed herein.

FIGS. 2A, 2B, and 2C demonstrate a system of levitation of a magnetic vehicle above a superconducting guideway in accordance with embodiments disclosed herein.

FIGS. 3A, 3B, 3C, and 3D demonstrate properties of a magnetic vehicle in accordance with embodiments disclosed herein.

FIGS. 4A, 4B, 4C, and 4D demonstrate magnetic properties of the superconducting guideway after field cooling in accordance with embodiments disclosed herein.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form to avoid obscuring the novel aspects of the disclosed embodiments. The language used in this disclosure has been principally selected for readability and instructional purposes and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

The figures and descriptions of the present invention may have been simplified to illustrate elements that are relevant for a clear understanding of the present embodiments while eliminating (for purposes of clarity) other elements found in, for example, a typical superlev vehicle system or typical method of transport using a superlev vehicle system, a typical electrical power transmission system including an electrical power delivery system or typical electrical power transmission/delivery method, or a typical fluid transportation system or typical fluid transportation method. Those of ordinary skill in the art will recognize that other elements may be desirable and/or required in order to implement the present embodiments. However, because such elements are well known in the art, and because they do not facilitate a better understanding of the present embodiments, a discussion of such elements may not be provided herein. It is also to be understood that the drawings included herewith only provide diagrammatic representations of the structures of the embodiments. The specific structure falling within the scope of the embodiments presented herein may include structures different than those shown in the drawings. It should also be understood that the phraseology and terminology employed herein are merely for descriptive purposes and should not be considered limiting.

In general, embodiments disclosed herein are directed to a superlev vehicle system capable of electrical power transmission/delivery; fuel (gas or liquid) transport; and/or the transportation of people (or other living or non-living entities) and/or goods (or other items). That is, embodiments include a superconductor levitated transportation system (referred to herein as a “superlev” system) that includes one or more superconductors and a coolant. Embodiments also include a combination of the superlev vehicle system and an electrical power transmission/delivery system that transports electrical power along the superconductor. Embodiments also include a combination of the superlev vehicle system and a fluid transportation system that transports fluid a distance within a conduit along a track that includes the superconductor. One of ordinary skill in the art will appreciate upon reading this disclosure that some or all of those embodiments may be combined in a single superlev transportation system.

Embodiments disclosed herein overcome the high cost associated with individual systems directed to vehicle levitation, electricity transportation, and fuel transportation to provide a “superlev” system that may combine these multiple functions. Embodiments may combine lossless electrical power transmission and storage, transport and storage of liquid hydrogen (LH₂), liquid nitrogen (LN₂), and/or liquid natural gas (LNG), and high-speed levitated transport of people and/or goods over long distances in a single, economical system. In this superlev system, vehicles with magnets (or electromagnets) are levitated above a superconductor guideway (i.e., a “superlev”) that is also transmitting and storing electrical power. In some embodiments, LH₂ is transported by the system while cooling the superconductor. Additionally or alternatively, embodiments may also include LN₂ and/or LNG (and a vacuum layer to thermally insulate the LH₂).

The superlev vehicles may travel at 500-800 km/h (or even 1000 km/h if the system is further built inside a partially evacuated tube). Thus, embodiments disclosed herein have the potential to make continental passenger air travel and airborne freight transport obsolete when appropriately adapted personal vehicles, buses, and trucks are employed. In embodiments disclosed herein, additional land may not need to be acquired because the superlev system may be built into existing highway infrastructures. Thus, embodiments may provide superlev access to vehicles adapted for use on both standard roads and superlev system roads.

In contrast to current long-distance, high-speed mass transit and freight transport systems, the superlev system may provide additional flexibility because individuals may not be dependent on schedules and, further, goods may not have to be loaded or unloaded at specific points. The cost of each of the superlev system's many functions is only a fraction of the total costs. Also, the costs to maintain and operate the levitated components are minimal due to lack of friction, making the superlev system economically feasible overall.

Embodiments of the superlev vehicle and electrical power transmission system include a guideway with a superconductor and a coolant coupled to the superconductor. The superconductor may be configured to transmit electrical power. The coolant is configured to cool the superconductor. The coolant may include liquids such as hydrogen, nitrogen, and/or methane. The system also includes a vehicle configured to be levitated a distance from the track via interaction between a magnetic field of the vehicle and the magnetic field from the superconductor. The interaction of levitation is both repulsive and attractive, suspending the vehicle while also keeping the vehicle from exceeding a maximum distance from the track.

Embodiments also include an electrical power delivery system electrically coupled to the superconductor. For example, the superconductor may be in the form of a cable. Superconducting cables, such as high temperature superconducting (HTS) type, are known to provide power-dense electrical transmissions. In accordance with embodiments disclosed herein, the superconductors are capable of efficiently carrying large amounts of electrical power over long distances. Superconducting cables may be a potential replacement for conventional high-voltage cables as the backbone of a transmission grid. Embodiments disclosed herein are not limited to HTS type superconductors. Low Tc superconducting cable may also be considered based on the specific designs and costs. Superconducting cables are ideal for power transmission over long distances due to the absence of energy loss. Embodiments may use high-temperature superconductors to transmit power at the liquid-hydrogen temperature of 20 K or liquid nitrogen temperature of 77 K or even room temperature when superconductors superconducts above room temperature.

Embodiments also include a superconductor levitated vehicle and fluid transportation system. In such embodiments, the conduit includes the superconductor and the fluid for transporting. The fluid may be configured to be transported a distance within the conduit along the guideway. For example, if the production and usage of the fluid are at different places, embodiments may be used to transport the fluid accordingly. The fluid may be liquid fuel, for example hydrogen, methane, gasoline, and/or diesel.

Hydrogen is one of the cleanest energy source and may be part of a future clean energy landscape. For example, hydrogen may be produced by water electrolysis using surplus grid power during off-peak hours and/or renewable power generated by solar panels and wind turbines. When the grid requires more power, a portion of the stored electrical power in the superconductor can be immediately be provided to the grid or the liquid hydrogen may be converted back into electrical power to meet the demand. Accordingly, hydrogen transport built into the guideway in accordance with embodiments disclosed herein may help alleviate the high cost of transporting hydrogen, helping to move society to a cleaner landscape while helping to literally move people and/or goods.

In contrast to traditional systems, embodiments disclosed herein are built with the guideway including a superconductor and with the magnets inside the vehicle. As such, the cost of the system may be dramatically reduced. Magnets are very expensive and the cost of magnets contributes to a huge portion of the cost in traditional maglev systems. By incorporating the magnets into the vehicle, the overall number of the expensive magnets may be reduced.

The superconductor may be in the form of a cable built inside the guideway. Such configurations may save an enormous amount of construction cost and require less infrastructure and footprint. In some embodiments, a superconducting cable is located inside a well-insulated tube in which the coolant is stored. In the example of LH₂ as the coolant, with significant insulation, the loss of LH₂ may be minimized.

Embodiments provide three separate systems (a superconductor for power transmission, fuel and non-fuel transport, and people/goods transport) combined into one superlev system. The cost of embodiments may be reduced by a factor of about 3-10 when compared to the sum of the costs of each traditional independent system.

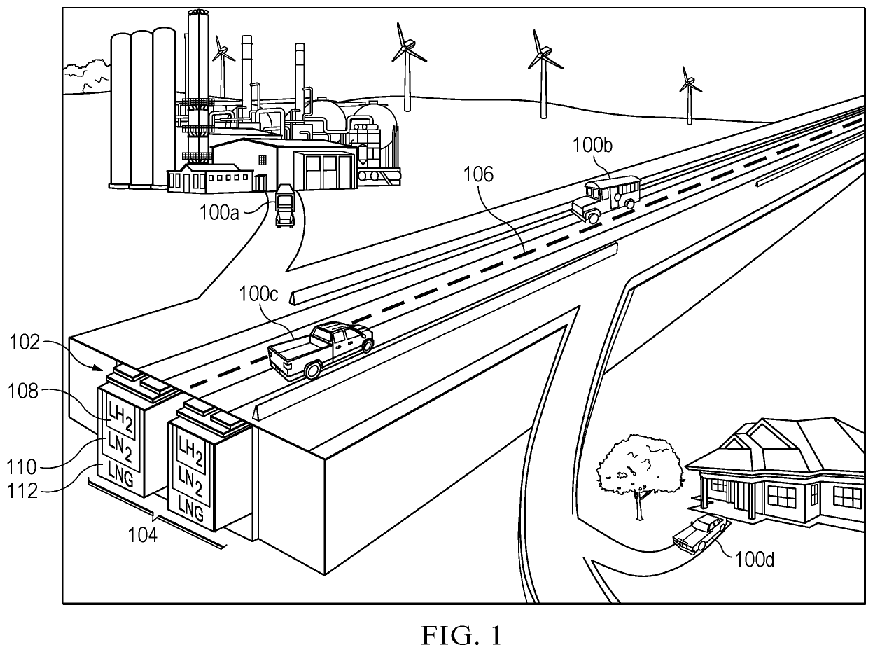

FIG. 1 is a schematic illustrating a superlev vehicle transport system in accordance with one or more embodiments disclosed herein.

The embodiments of FIG. 1 include multiple vehicles 100a, 100b, 100c, 100d (collectively, vehicles 100) along a guideway 106 and a superconductor 102 in a conduit 104 located below the guideway 106. One or more of the vehicles 100 may include the required magnets to levitate the vehicle 100 and couple to the superconductor 102. The superconductor 102 is located near the surface of the guideway 106 to facilitate the magnetic coupling for levitation.

As described below, the superlev vehicle transport system includes a conduit 104 for transporting and storing a coolant 108 for cooling the superconductor 102 below the superconducting transition temperature of the superconductor 102. In the embodiment of FIG. 1, the conduit 104 includes a LH₂ coolant 108, enclosed by a pathway 110 that includes LN₂, which is further enclosed by a pathway 112 for LNG. The LN₂ and the LNG may contribute to the insulation of the LH₂ coolant 108 in the conduit 104. The LH₂ coolant 108, the LN₂ pathway 110 and the LNG pathway 112 may be sealed under vacuum, either individually or collectively.

In embodiments disclosed herein, a vehicle 100 will be levitated in the air (or, potentially, within a vacuum tube similar to existing hyperloop-type maglev trains) by the interaction of a magnetic field from the vehicle 100 with a magnetic field from the cooled superconducting cable 102 in the conduit 104. For example, magnets (e.g., permanent magnets such as neodymium iron boron magnets, magnets generated by regular coils, or magnets generated by superconducting coils) may be included in one or more of the vehicles 100 to couple to the cooled superconducting cable 102 in the conduit 104. In accordance with embodiments disclosed herein, the superconductor 102 enables electrical power to be transmitted over long distances without losses. Meanwhile, only a tiny fraction of the electrical power from the superconductor 102 is needed to power each vehicle 100 overcome the air friction if not inside a vacuum tube.

In the examples demonstrated by FIG. 1, the conduit 104 is shown as being incorporated into a roadway. Such a roadway may have existed prior to the conduit 104 installation. However, embodiments disclosed herein are not limited to the incorporation of a conduit 104 into a roadway. Embodiments may also be incorporated into existing train tracks. Embodiments may further include systems that establish new paths of transportation, as in the traditional establishment of roads or railways. Similarly, although embodiments are described above with reference to a general vehicle 100, the superlev system described in embodiments herein may be used include other vehicle types, such as a trains buses, trucks, etc. Such an alternative is considered to be within the spirit and scope of the present invention.

Further, the superlev system may include a vehicle control system for controlling the magnetization of the vehicle 100 and/or an electrical current control system for controlling the electrical current in the superconducting cable 102. In some embodiments, a central control system may be employed for controlling both the vehicle 100 and the electrical current in the superconducting cable 102.

The conduit 104 includes a coolant 108 to cool the superconductor 102 below the superconducting transition temperature of the superconductor 102. In some embodiments, LH₂ (at 20 K) may be used as the coolant 108 to cool the superconductor 102. Meanwhile, because LH₂ may also be used a fuel and energy source, in some embodiments the superlev system can be used to transport LH₂ from location to location (to be used as a fuel) while also cooling the superconductor 102. In some embodiments, the conduit 104 may include a non-energy carrier, such as liquid nitrogen. The non-energy carrier may be used as a coolant 108 or in addition to the coolant 108. One of ordinary skill in the art will appreciate that selection of the coolant 108 depends on the specific superconductor 102 used to ensure that the superconductor 102 remains below the superconducting transition temperature of the superconductor 102. For example, the coolant 108 may include a liquid such as hydrogen, nitrogen, and/or methane.

In other embodiments, other coolants 108 such as gas-to-liquid (GTL) or non-liquid coolants (e.g., a supercritical fluid or a multiple-phase mixture) may alternatively be employed. The temperature of the coolant 108 may range from 4.2 K to 300 K, provided the superconducting transition temperature of the superconductor 102 is higher than the temperature of the coolant 108. For example, liquid helium for low temperature superconductors 102 such as Nb₃Sn, NbTi, MgB₂, FeSe, YBCO, Bi-2212 and Bi-2223, Tl-2212 and Tl-2223, Tl-1212 and Tl-1223, Hg-2212 and Hg-2223, Hg-1212 and Hg-1223, etc., may be used. Liquid hydrogen may be used for low temperature superconductors 102 such as Nb₃Sn, NbTi, MgB₂, FeSe, YBCO, Bi-2212 and Bi-2223, Tl-2212 and Tl-2223, Tl-1212 and Tl-1223, Hg-2212 and Hg-2223, Hg-1212 and Hg-1223, etc. Liquid nitrogen may be used for low and high temperature superconductors 102 such as YBCO, Bi-2212 and Bi-2223, Tl-2212 and Tl-2223, Tl-1212 and Tl-1223, Hg-2212 and Hg-2223, Hg-1212 and Hg-1223, etc. Other synthetic fluids such as specialized refrigeration fluids may be used provided the temperature is below the superconducting transition temperature of the superconductor 102.

In embodiments herein, the coolant 108 serving to cool the superconductor 102 while also being an energy carrier that is ultimately transported a distance within a conduit 104 along the guideway 106. In such embodiments, the “dual-duty” coolant 108 may be contained within a single conduit 104 of the guideway 106. Alternatively, the energy carrier may be separate from the coolant 108 in another conduit 104 of the guideway 106, separate from the coolant's conduit 104. In such embodiments, the energy carrier would not be in contact with the superconducting cable 102.

The system may also be used to transport LH₂, LN₂, and/or LNG in accordance with embodiments disclosed herein.

After a guideway 106 is constructed, the superconductor 102 may be cooled with or without the magnetic field required for levitation. This is referred to field-cooled (with magnetic field) or zero field-cooled (without magnetic field). In the case that a large amount of electrical power is not being transmitted in the superconductor 102 under zero field-cooled, magnetization of the superconductor 102 is needed to pin the magnetic flux in order to levitate and guide a vehicle.

In the case when a large amount of electrical power is being transmitted by the superconductor 102, the superconductor 102 will generate a magnetic field. In the case that the magnetic field generated is either too large or too small than the required magnetic field for levitation and control, additional adjustment on the amount of power in the superconducting cables 102 or additional magnetization may be needed. The levitation force to control and guide the vehicle 100 may be determined based on the weight of the vehicle 100, properties of the superconductor 102 (such as cable size), the amount of power being carried, the speed, acceleration and deceleration of the vehicle 100, etc. Typically, vehicles 100 are suspended about 2-20 cm above the guideway 106 to ensure the vehicle 100 does not exceed a maximum distance from the guideway 106.

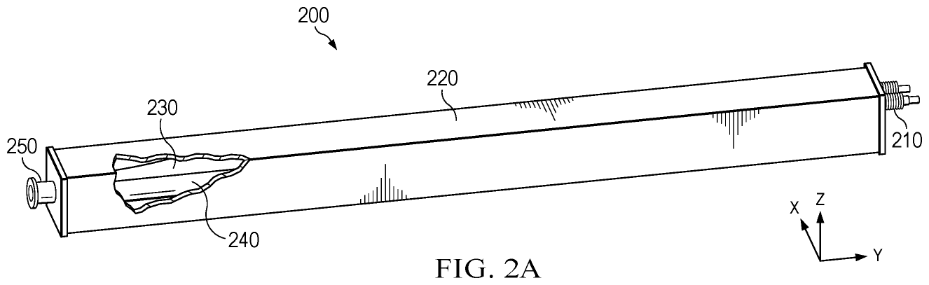

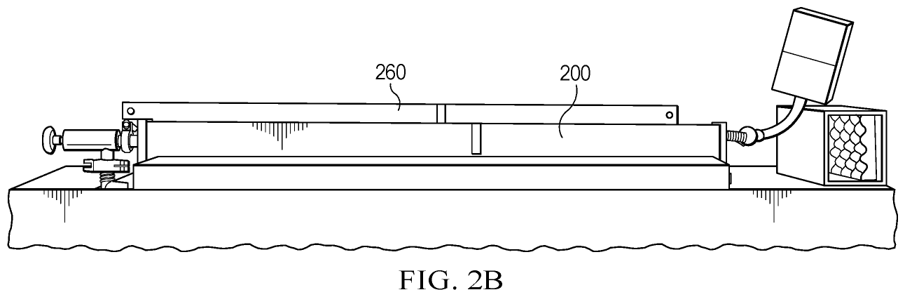

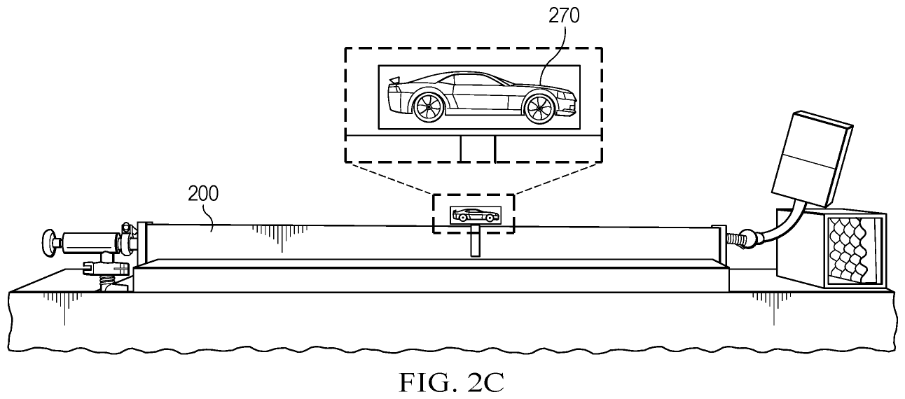

FIG. 2 includes FIGS. 2A through 2C and demonstrates the feasibility of the superconducting guideway 106 in accordance with embodiments disclosed herein. FIG. 2 shows a desktop superconducting guideway (SCG) 200 that includes a bulk yttrium barium copper oxide (YBCO) superconductor 102. The desktop SCG 200 allows a permanent magnet to levitate and move. The desktop SCG 200 uses LN₂ as the coolant 108 for experimental ease and to model the use of LH₂ used in some embodiments disclosed herein. When LH₂ is used, the levitating force of a YBCO guideway 106 will be significantly larger when compared to using LN₂.

Although YBCO superconductors 102 are commercially available in bulk and superconducting tape forms, embodiments disclosed herein are not limited to a YBCO SCG 200. In addition to the superconductors 102 mentioned above in relation to the coolants 108, other superconducting compounds, such as those in the bismuth (BSCCO) and mercury (HBCCO) families may be used. Further, provided the appropriate cooling and levitation requirements are achieved, unconventional superconducting materials like magnesium diboride (MgB₂) may also be considered.

FIG. 2A shows a CAD drawing of the SCG 200 demonstrated in FIG. 2. The SCG 200 includes LN₂-filling tubes 210, an outer vacuum casing 220, a linear array of nine YBCO bars 230, an inner LN₂ tube 240, and a vacuum valve 250. Each YBCO bar is one-half of a standard three-seed YBCO bulk sample and measures 82 mm×16 mm×12 mm.

To cool the YBCO array to below its transition temperature T_{c} (and maintain that temperature), the array is thermally attached to a rectangular aluminum tube, the inner LN₂ tube 240, that can store up to 250 mL LN₂. To prevent warming, the YBCO array is wrapped with multi-layered insulation and, along with the inner LN₂ tube 240, is housed in the outer vacuum casing 220, a rectangular aluminum tube that is 800 mm long with equal side widths of 60 mm.

The vacuum value 250 is used to provide evacuation to below 5×10⁻⁵ mbar, and the SCG 200 is cooled with LN₂ via periodic pouring into the LN₂-filling tubes 240. After 20 min and 1.5 L of LN₂, thermal equilibrium of 77 K is achieved. Without further LN₂ refilling, the moderate thermal loss of 2.5 W allows this temperature to be maintained for 3-4 h.

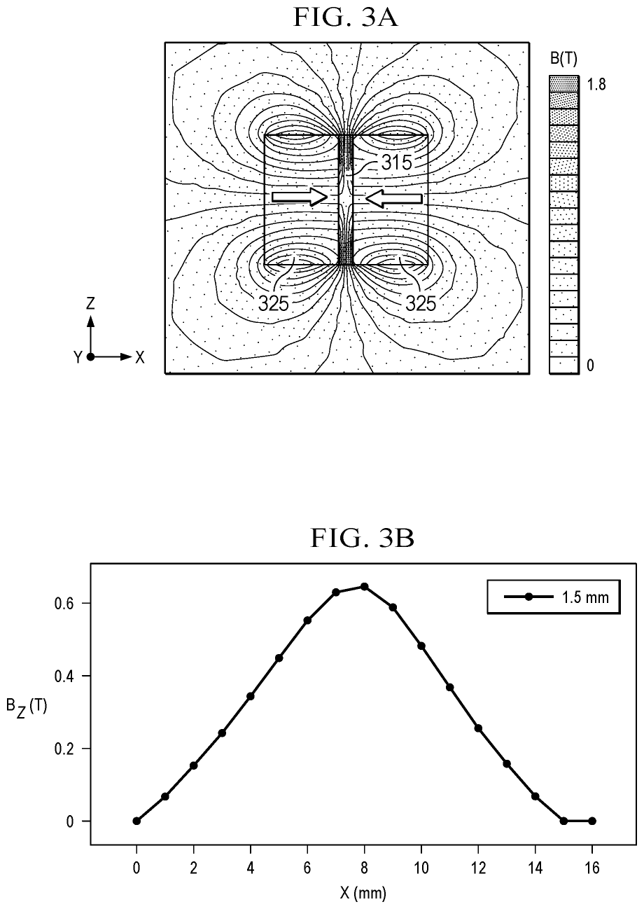

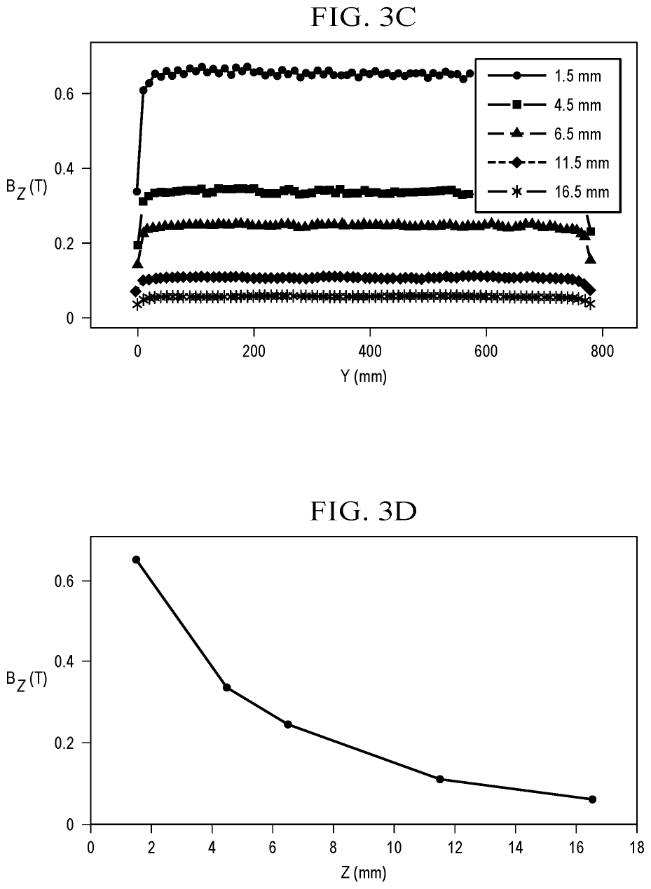

FIG. 2B demonstrates the levitation of a permanent magnet magnetizer (PMM) 260. The PMM 260 is 780 mm long and consists of a series of double repulsive arrays of NdFeB (N45) permanent magnetic blocks, separated by an iron plate collector and housed in a rectangular aluminum tube with a wall thickness of 1.5 mm. Each NdFeB block measures 20 mm×20 mm×10 mm, whereas the iron plate collector has a width of 2 mm and serves to turn, amplify, and homogenize the magnetic flux density. The PMM 260 weighs about 3 kg. Further details regarding the magnetic flux density of the PMM 260 is shown in FIG. 3.

To activate the SCG 200, field cooling (FC) magnetization is applied by placing the PMM 260 between 3-6 mm above the SCG 200 using spacers (not shown) and cooling the SCG 200 down to 77 K. When thermal equilibrium is achieved in the SCG 200, a trapped magnetic flux density B_{T} (hereafter B_{T} indicates the |B_{z}|component of vector B) is retained throughout the a linear array of nine YBCO bars 230 after removal of the PMM 260 due to the trapped flux and resultant induced superconducting current.

Following the FC magnetization procedure, the spacers are removed from between the PMM 260 and the SCG 200 and the PMM 260 levitates above the SCG 200, as shown in FIG. 2B. As expected, the PMM 260 moved freely in both directions along the length of the SCG 200.

FIG. 2C demonstrates the levitation of a miniature magnetic vehicle 270. The miniature magnetic vehicle 270 has the same magnetic structure as the PMM 260, but is only 70 mm long. The inset of FIG. 2C demonstrates a gap of about 3 mm between the miniature magnetic vehicle 270 and the SCG 200.

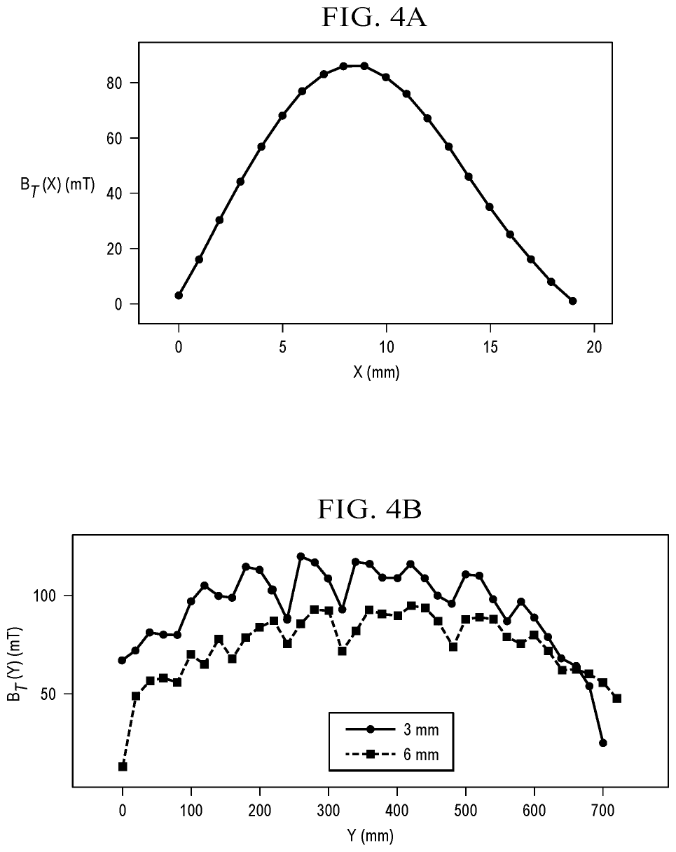

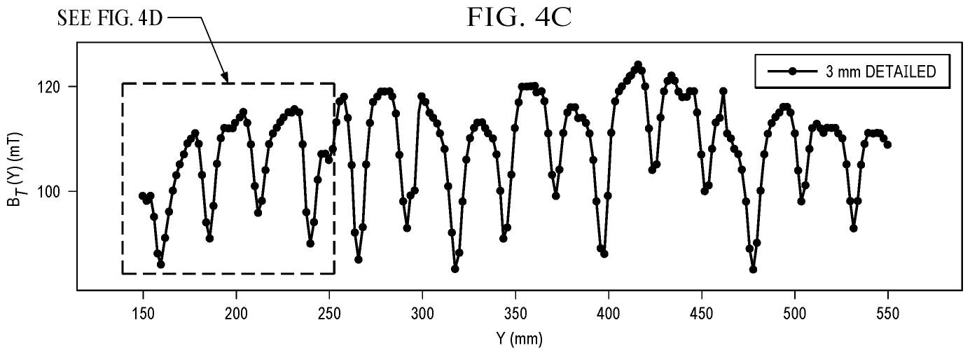

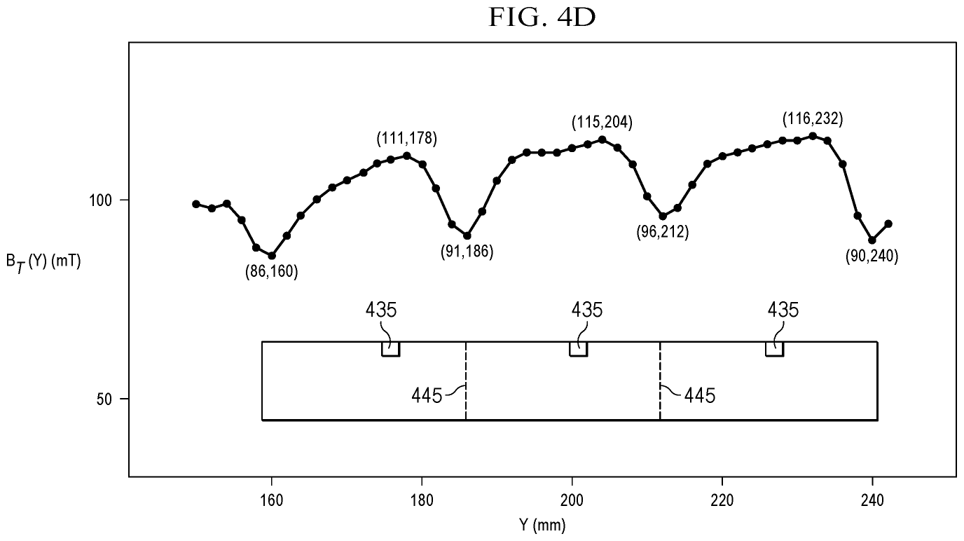

Following the FC magnetization procedure, the PMM 260 is removed and the miniature magnetic vehicle 270 is placed above the SCG 200. The miniature magnetic vehicle 270 levitates above the SCG 200 as shown in FIG. 2C. As expected the miniature magnetic vehicle 270 easily moved in directions along the length of the guideway 106. However, it was observed that the miniature magnetic vehicle 270 does not move as freely as the PMM 260 when levitating due to the inhomogeneities of the trapped flux in the SCG 200. Such inhomogeneities are discussed further with respect to FIG. 4.

Several FC magnetization procedures at distances in the 1-10 mm range were performed. At distances below 3 mm, the miniature magnetic vehicle 270 can collide with the SCG 200. At FC magnetization procedures at distances of 3-4 mm, the miniature magnetic vehicle 270 stably levitates and can move along the length of the SCG 200. However, at greater distances, the levitation can become unstable, particularly in the lateral direction, due to the arrangement of the magnets inside the miniature magnetic vehicle 270 and the narrowness of the SCG 200. Accordingly, embodiments disclosed herein may include arrangements of magnets in the vehicle configured in relation to the narrowness of the magnetic fields in the guideway 200 to avoid instabilities.

FIG. 3 includes FIGS. 3A through 3D and illustrates the magnetic properties of the PMM 260 of FIG. 2B. FIG. 3A shows a schematic magnetic configuration of the PMM 260 that includes an iron plate 315 and the NdFeB magnets 325. The surface of the PMM 260 was characterized via Hall mapping. FIG. 3B shows the magnetic flux density B_{z}(x) at z=1.5 mm of the surface of the PMM 260. In this context, z denotes the distance between the upper surface of the NdFeB magnet and the Hall probe. The measured B_{z}(x) exhibits a homogeneous triangular profile with a peak (^{p}B_{z}) of about 648 mT.

FIG. 3C shows the measured ^{p}B_{z}(y) along the PMM 260 at different z distances of 16.5 mm, 11.5 mm, 6.5 mm, 4.5 mm, and 1.5 mm. In FIG. 3C, the largest z distance (16.5 mm) resulted in the lowest measured ^{p}B_{z}(y) while the shortest z distance (1.5 mm) resulted in the largest measured ^{p}B_{z}(y). FIG. 3D shows the mean value of the measured ^{p}B_{z}(y) shown in FIG. 3C as a function of the distance z. The measured ^{p}B_{z}(y) data shows that the PMM 260 has a nearly constant magnetic flux density with a minor ^{p}B_{z}(y) deviation of less than 3%.

FIG. 4 includes FIGS. 4A through 4D and illustrates the magnetic properties of the SCG 200 of FIG. 2. FIG. 4A shows the magnetic flux density of the SCG 200 along the x axis after an FC magnetization procedure at 3 mm. FIG. 4A shows that, after FC at 3 mm, B_{T} exhibits a triangular profile along the x axis and reaches maximum at ^{p}B_{T}(x)=86 mT. The slight B_{T}(x) asymmetry observed is related to the steeper trapped field gradient in the vicinity of the seed surface cut.

FIG. 4B shows the magnetic flux density of the SCG 200 along the y axis with an FC magnetization procedure performed at a distance of 3 mm (upper data) and 6 mm (lower data). The data shown in FIG. 4B demonstrates a series of maxima and minima, showing the none uniformity of the induced flux as a result of the superconductor grown with the seeds.

Also, the B_{T} value decreases with increasing FC distance, along with a corresponding decrease in the B_{T}(y) variation between maxima and minima. These observations are consistent with previous observations that found that the FC distance may play a functional role in changing the shape and magnitude of the B_{T} distribution in trapped field applications. These observations also point out that a multi-seed YBCO bulk sample may provides superior levitation performance compared to a corresponding array of single-grain YBCO bulk samples due to the additional induced supercurrent in intergrain coupling.

To evaluate the field distribution in more detail, the 77 K FC magnetization procedure at a distance of 3 mm. FIG. 4C shows the measured B_{T}(y) for 150 mm≤y≤550 mm at 2 mm intervals. This B_{T}(y) behavior mirrors the macro-scale structure of at least three YBCO bars within the measurement range. More specifically, the three maxima in the 150 mm≤y≤240 mm range [B_{T}(mT), y(mm)]=[(111,178); (115,204); (116,232)] shown in magnified detail in FIG. 4D are consistent with the actual seed locations 435 of a YBCO bar, as shown schematically in the inset of FIG. 4D. The first and fourth minima [(86,160) and (90,240), respectively] reflect one three-seed 435 YBCO bar in the array, whereas the second and third minima [(91,186) and (96,212), respectively] correspond to the locations the grain boundaries 445, which are 26 mm apart.

These maxima and minima may be easily eliminated by using two or more layers of YBCO bars, with each layer shifted a certain distance to overlap the maxima and minima. However, movement of a vehicle 100 along an SCG 200 may be negatively affected by the inhomogeneous B_{T}(y) resulting from the grain boundaries in the YBCO bars and the joint gaps between them. Thus, embodiments disclosed herein may engineer the superconductor 102 to avoid such an inhomogeneous B_{T}(y). This may be accomplished through engineered grain boundaries 445 and/or multiple layers of the superconductor 102 in the SCG 200. In this demonstration, HTS tapes may be used in place of (or in combination with) the YBCO bulk array to alleviate the inhomogenities.

FIGS. 2-4 provide a demonstration of the feasibility of superlev systems in accordance with embodiments disclosed herein. FIGS. 2-4 demonstrate levitation of a permanent magnet vehicle above a guideway 106 that includes a superconductor 102, in contrast to traditional designs. One of ordinary skill in the art will appreciate that the inner LN₂ tube demonstrated above may easily be converted into a means of transportation and storage of a coolant 108 (such as LH₂). Further, additional conduits 104 for the transportation and storage of other liquids and/or gases may be easily incorporated into the SCG 200.

Embodiments disclosed herein are further directed to a method of transport. The method of transport may be used to transport vehicles 100, electricity, coolant 108, and/or fuel. The method includes providing a guideway 106 that includes a superconductor 102 and a coolant 108 coupled to the superconductor 102, and cooling the superconductor 102 using the coolant 108. The method also includes generating a magnetic field from a vehicle 100 and generating a magnetic field from the superconductor 102 via conduction of electrical current in the superconducting cable 102. The vehicle is levitated a distance from the track via the interaction between the magnetic field from the vehicle and the magnetic field from the superconductor 102.

The method of transport may further include transmitting electrical power via the superconductor cable 102 for delivery of the electrical power. The method of transport may further include transporting a liquid or gas along the guideway 106 using a conduit 104 disposed with the superconductor 102.

The method steps in any of the embodiments described herein are not restricted to being performed in any particular order. Also, structures mentioned in any of the method embodiments may utilize structures mentioned in any of the device/system embodiments. Such structures may be described in detail with respect to the device/system embodiments only but are applicable to any of the method embodiments.

It's understood that the above description is intended to be illustrative, and not restrictive. The material has been presented to enable any person skilled in the art to make and use the concepts described herein, and is provided in the context of particular embodiments, variations of which will be readily apparent to those skilled in the art (e.g., some of the disclosed embodiments may be used in combination with each other). Many other embodiments will be apparent to those of skill in the art upon reviewing the above description. The scope of the embodiments herein therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A superconductor levitation (superlev) vehicle system comprising:
a guideway for a vehicle;
a conduit, beneath the guideway, comprising:
a superconductor configured to generate a magnetic field and levitate the vehicle a distance from the guideway via interaction between the magnetic field generated by the superconducting cable and a magnetic field from the vehicle; and
a coolant, coupled to the superconductor, configured to cool the superconductor.

2. The system of claim 1, wherein the coolant comprises a liquid selected from the group consisting of hydrogen, nitrogen, and methane.

3. The system of claim 1, wherein the superconductor is a superconducting cable.

4. The system of claim 1, wherein the superconductor transmits electrical power along the guideway.

5. The system of claim 4, further comprising:
an electrical power delivery system electrically coupled to the superconducting cable.

6. The system of claim 1, wherein the conduit further comprises:
a fluid transportation system for transporting and storing fluids along the conduit.

7. A superconductor levitation (superlev) vehicle and fluid transportation system comprising:
a guideway for a vehicle;
a conduit, beneath the guideway, comprising:
a superconductor configured to generate a magnetic field and levitate the vehicle a distance from the guideway via interaction between the magnetic field generated by the superconducting cable and a magnetic field from the vehicle; and
a fluid configured to be transported a distance within the conduit and stored along the guideway.

8. The system of claim 7, wherein the fluid comprises a liquid fuel.

10. The system of claim 8, wherein the liquid fuel comprises hydrogen, methane, gasoline, or diesel.

11. The system of claim 7, wherein the fluid comprises a gas.

12. The system of claim 7, wherein the fluid comprises a coolant, coupled to the superconducting cable, configured to cool the superconducting cable.

13. The system of claim 12, wherein the coolant comprises a liquid comprising hydrogen, nitrogen, or methane.

14. The system of claim 7, wherein the superconducting cable is configured to transmit and store electrical power.

15. The system of claim 14, further comprising an electrical power delivery system electrically coupled to the superconducting cable.

16. A method of transport and storage, the method comprising:
providing a conduit below a guideway for a vehicle, the conduit comprising:
a superconductor; and
a coolant coupled to the superconductor;
generating a magnetic field from the superconductor via conduction of electrical current in the superconductor;
levitating the vehicle a distance from the guideway via interaction between the magnetic field generated by the superconductor and the magnetic field; and
cooling the superconductor using the coolant.

17. The method of claim 16, further comprising:
transporting and storing electrical power using the superconductor.

18. The method of claim 16, further comprising:
transporting and storing a fluid using the conduit.

19. The method of claim 18, wherein the fluid comprises a liquid fuel.

20. The method of claim 19, wherein the liquid fuel comprises hydrogen, methane, gasoline, or diesel.
